(19) United States
(12) Patent Application Publication
(10) Pub. No.: US 2025/0145183 A1
(43) Pub. Date: May 8, 2025

(54) AUTONOMOUS DRIVING VEHICLE AND CONTROL METHOD THEREOF

(71) Applicants: HYUNDAI MOTOR COMPANY, Seoul (KR); KIA CORPORATION, Seoul (KR)

(72) Inventor: Sang Hwa Lee, Hwaseong-si (KR)

(73) Assignees: HYUNDAI MOTOR COMPANY, Seoul (KR); KIA CORPORATION, Seoul (KR)

(21) Appl. No.: 18/937,634

(22) Filed: Nov. 5, 2024

(30) Foreign Application Priority Data
Nov. 6, 2023 (KR) 10-2023-0151647

(51) Int. Cl. B60W 60/00; B60W 50/14

(52) U.S. Cl. CPC B60W 60/0059; B60W 50/14; B60W 2050/146; B60W 2300/14; B60W 2520/105; B60W 2530/203

(57) ABSTRACT

A method of controlling an autonomous vehicle includes: under control of a processor, acquiring, using a communication unit, a signal indicative of connection between the autonomous vehicle and a trailer; activating an autonomous driving based on the signal; learning a speed-specific acceleration pattern of the autonomous vehicle based on the activated autonomous driving; determining overloading by comparing and analyzing the learned acceleration pattern with a preset normal pattern; and determining whether to maintain the activated autonomous driving based on a result of the determination on the overloading.

### CROSS-REFERENCE TO RELATED APPLICATION

This application claims the benefit of and priority to Korean Patent Application No. 10-2023-0151647, filed on Nov. 6, 2023, the entire contents of which are incorporated herein by reference.

### BACKGROUND

### Technical Field

The present disclosure relates to an autonomous vehicle and a control method thereof, which recognize a warning or control operation situations of an autonomous driving and establish a criterion for comprehensive determination.

### Discussion of Related Art

Autonomous vehicles, which may reduce driver fatigue by performing driving, braking, and steering on behalf of drivers, are recently required to have the ability to adaptively respond to surrounding situations that change in real time while driving.

For example, a smart cruise control (SCC) function, one of the autonomous driving features, is a driving comfort feature that assists a vehicle in traveling at a speed set by a driver while maintaining a distance from a vehicle ahead. To accelerate and decelerate to the speed set by the driver, and maintain the distance from the vehicle ahead, tuning may be performed for each vehicle model in a development phase, and in this case, the function may be affected by the engine and transmission.

On the other hand, a C-CAN type trailer module (CTM), which is a controller area network (CAN) signal-based trailer module, may operate the tail lamps of a trailer and determine whether the trailer is fastened or connected.

A signal provided by the CTM may be used only to determine whether the trailer is fastened or connected, without providing information about the type or weight of the trailer. In countries where the usage of trailers is relatively high, a trailer mounting determination module may be used to, when a trailer is connected to a vehicle, determine a trailer mounting state by communicating with the vehicle.

However, typical autonomous vehicles may forcibly turn off some of the autonomous driving features when it is determined that a trailer is mounted or connected due to safety concerns about the autonomous driving and may deactivate the autonomous driving features regardless of the weight and size of the trailer, which may lead to consumers raising complaints about product quality.

The statements in this section merely provide background information related to the present disclosure and may not constitute prior art.

### SUMMARY

An object of the present disclosure is to provide an autonomous vehicle and a control method thereof that may sense the loading amount of a trailer and a vehicle when the trailer is mounted even while the trailer is connected to a trailer mounting determination module and determine whether to activate an autonomous driving based on a result of the sensing, thereby improving both the stability of using the autonomous driving and the satisfaction of consumers.

The technical objects to be achieved by the present disclosure are not limited to those described above, and other technical objects not described above may also be clearly understood by those having ordinary skill in the art from the following description.

To solve the preceding technical problems, according to an embodiment of the present disclosure, there is provided a method of controlling an autonomous vehicle. The method includes: acquiring, by a processor, a signal indicative of connection between the autonomous vehicle and a trailer; activating, by the processor, an autonomous driving based on the acquired signal; and learning, by the processor, an acceleration pattern of the autonomous vehicle based on the activated autonomous driving. The method further includes: determining, by the processor, overloading by comparing the learned acceleration pattern with a preset normal pattern; and determining, by the processor, whether to maintain the activated autonomous driving based on a result of the determination on the overloading.

The method may also include: in response to determination of the overloading, deactivating, by the processor, the autonomous driving; and providing information related to the deactivated autonomous driving through a display such as a user setting mode (USM) and an instrument cluster.

The method may also include: in response to determination that there is no overloading, maintaining, by the processor, the activated autonomous driving.

The preset normal pattern may include a first normal pattern and a second normal pattern. The determining of overloading may include determining the overloading based on the first normal pattern when the autonomous vehicle and the trailer are determined as being connected based on the signal.

The determining of overloading may also include determining the overloading based on the second normal pattern when the autonomous vehicle and the trailer are determined as not being connected based on the signal.

The autonomous driving may include a smart cruise control (SCC).

To solve the preceding technical problems, according to an embodiment of the present disclosure, there is provided a non-transitory computer-readable recording medium having a program recorded thereon. The program is configured to direct a processor to perform acts of: acquiring a signal indicative of connection between an autonomous vehicle and a trailer; activating an autonomous driving based on the acquired signal; learning an acceleration pattern of the autonomous vehicle based on the activated autonomous driving; determining overloading by comparing the learned acceleration pattern with a preset normal pattern; and determining whether to maintain the activated autonomous driving based on a result of the determination on the overloading.

To solve the preceding technical problems, according to an embodiment of the present disclosure, there is provided an autonomous vehicle including a processor. The processor may be configured to: acquire a signal indicative of connection between the autonomous vehicle and a trailer; activate an autonomous driving based on the acquired signal; learn a speed-specific acceleration pattern of the autonomous vehicle based on the activated autonomous driving; determine overloading by comparing and analyzing the learned acceleration pattern and a preset normal pattern; and determine whether to maintain the activated autonomous driving based on a result of the determination on the overloading.

When the overloading is determined, the processor may be further configured to: deactivate the autonomous driving, and provide information about the deactivated autonomous driving through a display such as user setting mode (USM) and an instrument cluster.

The processor may be further configured to maintain the activated autonomous driving when no overloading is determined (e.g., underloading).

The preset normal pattern may include a first normal pattern and a second normal pattern, and the processor may be configured to determine the overloading based on the first normal pattern when the autonomous vehicle and the trailer are connected based on the signal.

The processor may be configured to determine the overloading based on the second normal pattern when the autonomous vehicle and the trailer are not connected based on the signal.

The autonomous driving may include the SCC.

The autonomous vehicle and the control method configured as described above according to embodiments of the present disclosure may detect or sense a loading amount of a trailer and the autonomous vehicle when the trailer is mounted even while the trailer is connected to a trailer mounting determination module and determine whether to activate an autonomous driving based on a result of the sensing, thereby improving both the stability of using the autonomous driving and the satisfaction of consumers.

Further, as described above according to embodiments of the present disclosure, the autonomous vehicle and the control method may determine a loading level of a vehicle equipped with an SCC function by comparing an acceleration degree of the vehicle in a normal state with an acceleration degree of the vehicle in a loaded state depending on a connection state between a trailer mounting determination module and a trailer. The autonomous vehicle and the control method may deactivate the autonomous driving when the determined loading level exceeds an allowable value, thereby avoiding or preventing erroneous control and increasing the stability of using the autonomous driving.

Further, the autonomous vehicle and the control method, configured as described above according to embodiments of the present disclosure, may inform a consumer of a deactivated function through a disabled USM and a cluster pop-up, thereby avoiding or preventing an unexpected accident that may occur when using an autonomous driving.

Further, the autonomous vehicle and the control method, configured as described above according to embodiments of the present disclosure, may use an autonomous driving when it is determined that the autonomous driving is not affected by the connection of a trailer based on a determination of a loading state, as opposed to deactivating the autonomous driving when it is determined that the trailer is connected or fastened.

Further, the autonomous vehicle and the control method, configured as described above according to embodiments of the present disclosure, may use an acceleration pattern of an SCC function in a normal state and an acceleration pattern of the SCC function learned in an overloading state to relatively accurately determine an overloading state without requiring a trailer mounting determination module such as a C-CAN type trailer module (CTM).

Further, the autonomous vehicle and the control method, configured as described above according to embodiments of the present disclosure, may visually warn a driver of an overloading state and the availability of an autonomous driving through a USM and a cluster.

The effects that can be achieved from the present disclosure are not limited to those described above, and other effects not described above may also be clearly understood by those having ordinary skill in the art from the following description.

### BRIEF DESCRIPTION OF THE DRAWINGS

FIG. 1 is a block diagram illustrating an autonomous vehicle, according to an embodiment of the present disclosure.

FIG. 2 is a flowchart illustrating a method of controlling an autonomous vehicle, according to an embodiment of the present disclosure.

FIG. 3 is a diagram illustrating learning an acceleration pattern in a state where a trailer is connected to an autonomous vehicle, according to an embodiment of the present disclosure.

FIG. 4 is a diagram illustrating learning an acceleration pattern in a state where a trailer is not connected to an autonomous vehicle, according to an embodiment of the present disclosure.

FIG. 5 is a diagram illustrating the activation of an autonomous driving based on an acceleration pattern, according to an embodiment of the present disclosure.

### DETAILED DESCRIPTION OF THE DISCLOSURE

Hereinafter, embodiments of the present disclosure are described in detail with reference to the accompanying drawings, and the same or similar elements are given the same reference numerals regardless of reference symbols, and a repeated description thereof has been omitted. Further, when describing the embodiments, when it is determined that a detailed description of related publicly known technology obscures the gist of the embodiments described herein, the detailed description thereof is omitted.

The following description is provided to illustrate some embodiments of the present disclosure and are not intended to limit the present disclosure, application, or uses.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the embodiments with reference to the accompanying drawings, like reference numerals refer to like components and a repeated description related thereto is omitted.

In addition, the terms “unit” and “control unit” included in names such as a vehicle control unit (VCU) may be terms widely used in the naming of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and at least one vehicle controller that performs determination, calculation, selection, and the like necessary to control the function. The vehicle controller may also be referred to herein as a drive controller.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

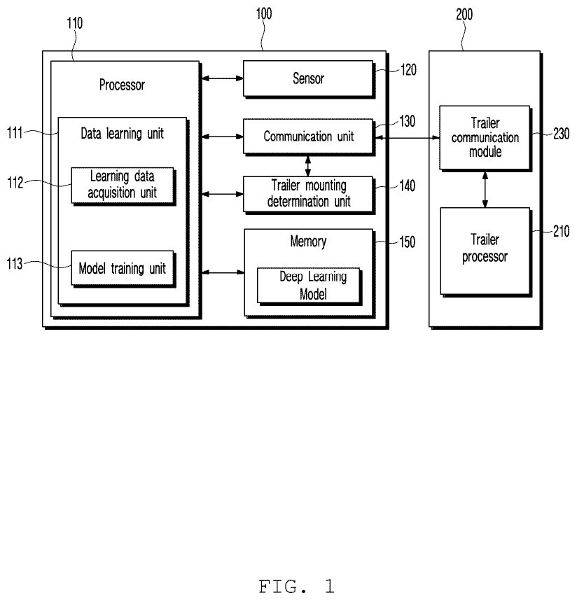

FIG. 1 is a block diagram illustrating an autonomous vehicle according to an embodiment of the present disclosure.

Referring to FIG. 1, according to an embodiment, an autonomous vehicle 100 may have a trailer 200 connected or fastened to the autonomous vehicle 100.

The autonomous vehicle 100 may include a processor 110, a sensor 120, a communication unit 130, a trailer mounting determination unit 140, and a memory 150.

The processor 110 may be provided in the autonomous vehicle 100 to control the sensor 120, the communication unit 130, the trailer mounting determination unit 140, and the like.

For example, the processor 110 may use the communication unit 130 to acquire a signal (referred to as ‘connection signal’ hereinafter) related to connection between the autonomous vehicle 100 and the trailer 200, and the processor 110 may control an autonomous driving to be activated or deactivated based on the acquired connection signal.

For example, when the autonomous driving is activated, the processor 110 may learn a speed-specific acceleration pattern of the autonomous vehicle 100 based on the activated autonomous driving, and compare and analyze the learned acceleration pattern and a preset normal pattern to determine overloading.

The processor 110 may control whether to maintain the activated autonomous driving based on a determination result acquired by the determining.

For example, when the overloading is determined as a result of comparison and analysis from the comparing and analyzing, the processor 110 may deactivate the autonomous driving and provide information about the deactivated autonomous driving by a pop-up through a user setting mode (USM) and an instrument cluster.

Alternatively, when the overloading is not determined as the result of comparison and analysis, the processor 110 may maintain the activated autonomous driving.

The processor 110 may control operations associated with the driving of the autonomous vehicle 100. For example, the processor 110 may process sensing data or driver data to perform processing/determination and a control signal generation operation.

For example, the processor 110 may also process data acquired through interactions with other electronic devices provided in the autonomous vehicle 100 to control autonomous driving.

In addition, the processor 110 may train a neural network using a program stored in the memory 150. In particular, the processor 110 may train a neural network for recognizing data associated with the autonomous vehicle 100. In this case, the neural network for recognizing the data associated with the autonomous vehicle 100 may be designed to computationally simulate the structure of a human brain and may include a plurality of network nodes with weights that simulate neurons in a human neural network.

For example, the plurality of network nodes may each exchange information based on a connectivity relationship to simulate the synaptic activity of neurons that exchange signals through synapses. In this case, the neural network may include a deep learning model evolved from a neural network model. In the deep learning model, a plurality of network nodes may be positioned in different layers to exchange information based on convolutional connectivity relationships. The neural network model may include, as non-limiting examples, a deep neural network (DNN), a convolutional neural network (CNN), a recurrent neural network (RNN), a restricted Boltzmann machine (RBM), a deep belief network (DBN), and a deep Q-network, and may be applied to various technical fields such as computer vision, speech recognition, natural language processing, and speech/signal processing.

The processor 110 performing the functions described above may be a general-purpose processor (e.g., central processing unit (CPU)), and may also be an artificial intelligence (AI)-dedicated processor (e.g., graphics processing unit (GPU)) for AI learning.

The processor 110 may include a data learning unit 111 configured to train a neural network for data classification/recognition.

The data learning unit 111 may learn criteria for what learning data is to use to classify and recognize data and how to classify and recognize data using the learning data. The data learning unit 111 may train a deep learning model by acquiring learning data to be used for training the deep learning model and applying the acquired learning data to the deep learning model. The learning data may be, for example, data associated with speed-specific acceleration patterns of the autonomous vehicle 100.

The data learning unit 111 may be produced in the form of at least one hardware chip to be provided in the autonomous vehicle 100. For example, the data learning unit 111 may be produced in the form of a dedicated hardware chip for AI or produced as part of a general-purpose processor (e.g., CPU) graphics-only processor (e.g., GPU) to be provided in the autonomous vehicle 100.

The data learning unit 111 may also be implemented as at least one software module. When implemented as the software module (or a program module including instructions), the software module may be stored in a non-transitory computer-readable medium. In this case, the at least one software module may be provided by an operating system (OS) or an application.

The data learning unit 111 described above may include a learning data acquisition unit 112 and a model training unit 113.

The learning data acquisition unit 112 may acquire learning data required for a neural network model to classify and recognize data. For example, the learning data acquisition unit 112 may acquire, as the learning data, vehicle data and/or sample data to be input to the neural network model.

The model training unit 113 may use the acquired learning data to train the neural network model to have determination criteria for determining how to classify the data. In this case, the model training unit 113 may train the neural network model through supervised learning that uses at least a portion of the learning data as the determination criteria. Alternatively, the model training unit 113 may train the neural network model through unsupervised learning that uses the learning data for self-learning without supervision and finds the determination criteria.

In addition, the model training unit 113 may train the neural network model through reinforcement learning that uses feedback on whether a result of determining a situation by the learning or training is correct.

In addition, the model training unit 113 may train the neural network model using a learning algorithm including error backpropagation or gradient decent. Once the neural network model is trained, the model training unit 113 may store the trained neural network model in the memory 150.

The model training unit 113 may store the trained neural network model in a server connected to the autonomous vehicle 100 by a wire or wireless network.

The data learning unit 111 may further include a learning data preprocessing unit (not shown) and a learning data selection unit (not shown) to improve an analysis result of a recognition model or to save resources or time required to generate the recognition model.

The learning data preprocessing unit may preprocess acquired data such that the acquired data may be used for learning to determine a situation. For example, the learning data preprocessing unit may process the acquired data into a preset format such that the model training unit 113 may use the acquired learning data for learning to recognize an image.

The learning data selection unit may select data required for learning from the learning data acquired by the learning data acquisition unit 112 or the learning data preprocessed by the learning data preprocessing unit. The selected learning data may be provided to the model training unit 113. For example, the learning data selection unit may detect a specific region in an image acquired through a camera of the autonomous vehicle 100 and select only data of objects included in the specific region as the learning data.

The data learning unit 111 may further include a model evaluation unit (not shown) to improve an analysis result of the neural network model.

The model evaluation unit may input evaluation data to the neural network model, and when an analysis result output from the evaluation data does not satisfy a predetermined criterion, may allow the model training unit 113 to retrain the neural network model. In this case, the evaluation data may be predefined data for evaluating the recognition model. For example, when the number or ratio of pieces of the evaluation data in which an analysis result of the trained recognition model in the evaluation data is not accurate or exceeds a preset threshold value, the model evaluation unit may evaluate that the analysis result does not satisfy the predetermined criterion.

The sensor 120 may be provided as one or more sensors at the front, rear, and sides of the autonomous vehicle 100. The sensor 120 may sense, in real time, the surroundings of the autonomous vehicle 100 that is parked or traveling and provide sensing information to the processor 110. The sensor 120 may include, as non-limiting examples, a radar, a camera, a lidar, and a wheel sensor.

The communication unit 130 may be provided in the autonomous vehicle 100 to receive a connection signal and provide the received connection signal to the processor 110 and the trailer mounting determination unit 140.

For example, the communication unit 130 may include a controller area network (CAN), which is a message-based multiplex protocol designed to allow the processor 110 (or a microcontroller) and various devices to communicate with each other.

For example, the communication unit 130 may be connected to a trailer communication module 230 through wired or wireless communication to receive the connection signal from the trailer communication module 230 and transmit a control signal to the trailer communication module 230. The connection signal described herein may also be referred to herein as fastening data or information.

The trailer mounting determination unit 140 may be provided in the autonomous vehicle 100 and electrically connected to the communication unit 130 and the processor 110. In this case, under the control of the processor 110, the trailer mounting determination unit 140 may analyze the connection signal provided by the communication unit 130 and determine whether the autonomous vehicle 100 and the trailer 200 are fastened or connected based on the analyzed connection information.

The trailer mounting determination unit 140 may provide the processor 110 with the connection information about whether the autonomous vehicle 100 and the trailer 200 are fastened or connected.

The memory 150 may store various programs and data required to operate the autonomous vehicle 100. The memory 150 may be implemented as a non-volatile memory, a volatile memory, a flash memory, a hard disk drive (HDD), a solid-state drive (SSD), or the like. The memory 150 may be accessed by the processor 110, and the processor 110 may read, write, record, modify, delete, update, and the like data in the memory 150.

The memory 150 may also store a neural network model (e.g., a deep learning model) generated through a learning algorithm for data classification/recognition, in accordance with an embodiment of the present disclosure.

The trailer 200 may include a trailer processor 210 and the trailer communication module 230. The trailer 200 described herein may be a trailer for vehicles, for example.

The trailer processor 210 may be provided in the trailer 200, and may receive the control signal from the autonomous vehicle 100 through the trailer communication module 230 to control the trailer 200 based on the received control signal. For example, the trailer processor 210 may control the tail lamps of the trailer 200, the braking of the trailer 200, or the like, based on the control signal.

The trailer communication module 230 may be provided in the trailer 200, and may provide the connection signal to the autonomous vehicle 100 and receive the control signal from the autonomous vehicle 100, under the control of the trailer processor 210. The trailer communication module 230 may include, for example, a C-CAN type trailer module (CTM).

For example, the trailer communication module 230 may be a CAN signal-based trailer module of the trailer 200 to transmit and receive the connection signal. The connection signal may include data used to determine whether the autonomous vehicle 100 and the trailer 200 are fastened or connected to each other. For example, the connection signal provided by the CTM may be used to determine whether the trailer 200 is fastened (or connected). However, examples of the connection signal are not limited thereto, and the connection signal may also include data associated with the tail lamps of the trailer 200.

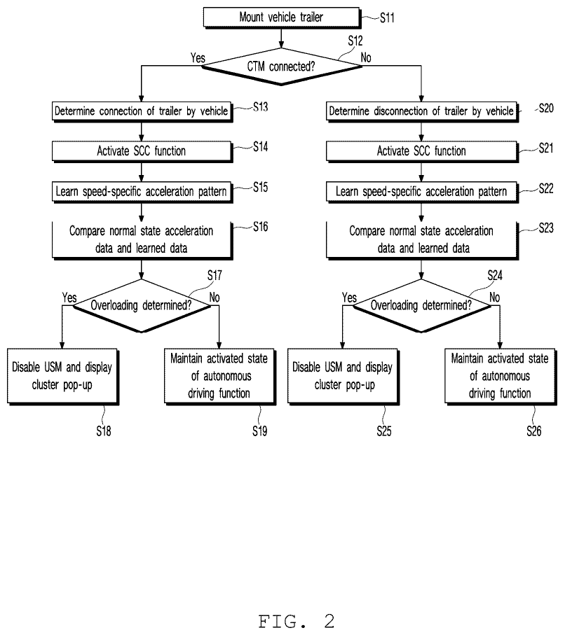

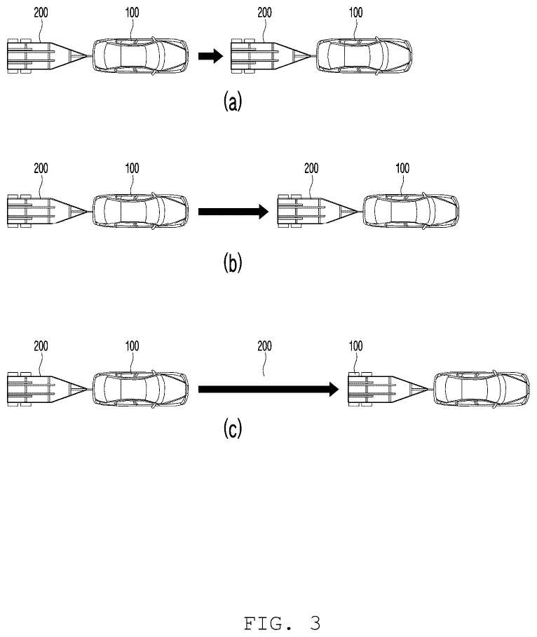

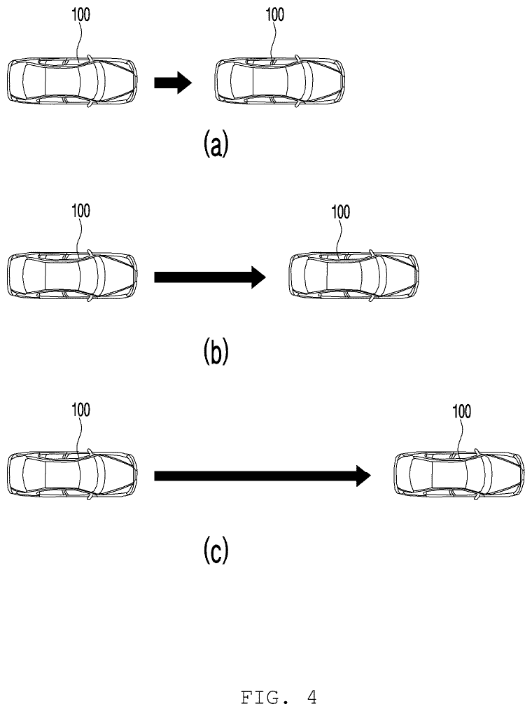

FIG. 2 is a flowchart illustrating a method of controlling an autonomous vehicle according to an embodiment of the present disclosure. FIG. 3 is a diagram illustrating learning an SCC acceleration pattern in a state where a trailer is connected to an autonomous vehicle, according to an embodiment of the present disclosure. FIG. 4 is a diagram illustrating learning an SCC acceleration pattern in a state where a trailer is not connected to an autonomous vehicle, according to an embodiment of the present disclosure.

Referring to FIG. 2, a method of controlling the autonomous vehicle 100 according to an embodiment of the present disclosure is as follows.

In step S11, the autonomous vehicle 100 may check whether the trailer 200 is mounted (or fastened or connected) to the autonomous vehicle 100.

The autonomous vehicle 100 may acquire a connection signal between the autonomous vehicle 100 and the trailer 200 using the communication unit 130, under the control of the processor 110. For example, under the control of the processor 110, the autonomous vehicle 100 may receive and analyze the connection signal provided by a CTM, which is the trailer communication module 230, through the communication unit 130 to determine whether the autonomous vehicle 100 and the trailer 200 are connected or fastened, in step S12.

Under the control of the processor 110, when, as a result of analyzing the provided connection signal, the autonomous vehicle 100 and the trailer 200 are determined as being connected or fastened in step S13, the autonomous vehicle 100 may activate an autonomous driving based on such a determination in step S14. The autonomous driving described herein may be a smart cruise control (SCC) function.

Subsequently, under the control of the processor 110, based on such a state where the trailer 200 is connected or fastened, the autonomous vehicle 100 may learn a speed-specific acceleration pattern of the autonomous vehicle 100 based on the activated autonomous driving in step S15.

Under the control of the processor 110, the autonomous vehicle 100 may acquire learning data to be used for the speed-specific acceleration pattern of the autonomous vehicle 100, and apply the acquired learning data to a deep learning model to train the deep learning model. The learning data described herein may be any data associated with the speed-specific acceleration pattern of the autonomous vehicle 100.

For example, as shown in (a) to (c) of FIG. 3, the autonomous vehicle 100 may learn a speed-specific acceleration pattern by acquiring learning data based on an SCC acceleration/deceleration pattern during driving and performing learning based on the acquired learning data, under the control of the processor 110.

For example, as shown in (a) of FIG. 3, the autonomous vehicle 100 may accelerate the autonomous vehicle 100 from a reference speed to a first speed while the autonomous driving is in an activated state to learn an acceleration pattern of the first speed, under the control of the processor 110.

Alternatively, as shown in (b) of FIG. 3, the autonomous vehicle 100 may accelerate the autonomous vehicle 100 from the reference speed to a second speed, which is faster than the first speed, while the autonomous driving is in the activated state to learn an acceleration pattern of the second speed, under the control of the processor 110.

Alternatively, as shown in (c) of FIG. 3, the autonomous vehicle 100 may accelerate the autonomous vehicle 100 from the reference speed to a third speed, which is faster than the second speed, while the autonomous driving is in the activated state to learn an acceleration pattern of the third speed, under the control of the processor 110.

Although FIG. 3 focuses on the acceleration pattern by speed, examples are not limited thereto. For example, instead of such a speed-specific acceleration pattern, the autonomous vehicle 100 may acquire learning data associated with a deceleration pattern while decelerating the autonomous vehicle 100 from the reference speed to a predetermined speed, and may learn a deceleration pattern by speed, or a speed-specific deceleration pattern, based on the acquired learning data.

Subsequently, under the control of the processor 110, the autonomous vehicle 100 may compare and analyze the learned acceleration pattern and a preset normal pattern in step S16 and determine overloading in step S17. In this case, the preset normal pattern may include a first normal pattern and a second normal pattern.

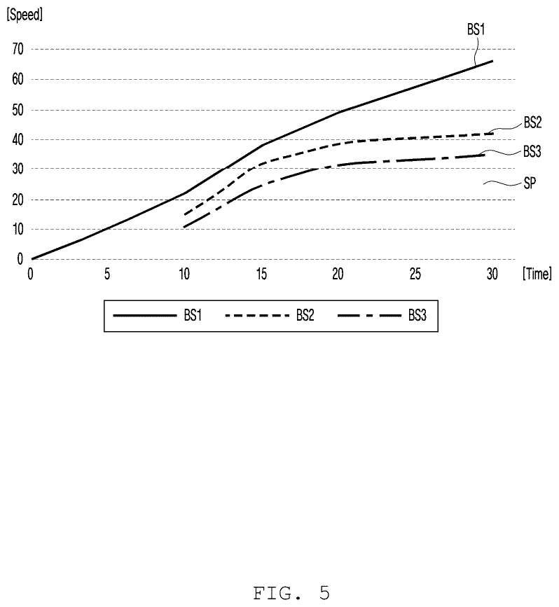

The first normal pattern may be a normal pattern set based on a case where the autonomous vehicle 100 and the trailer 200 are connected, and the second normal pattern may be a normal pattern set based on a case where the autonomous vehicle 100 and the trailer 200 are not connected. This configuration is described in more detail below with reference to FIG. 5.

Accordingly, under the control of the processor 110, the autonomous vehicle 100 may compare and analyze the learned acceleration pattern and the preset first normal pattern to determine overloading in step S17.

Under the control of the processor 110, when overloading is determined as a result of comparison and analysis acquired by the comparing and analyzing, the autonomous vehicle 100 may deactivate the autonomous driving and provide information about the deactivated autonomous driving through a USM and a cluster pop-up in step S18.

Alternatively, under the control of the processor 110, when overloading is not determined as the result of comparison and analysis, the autonomous vehicle 100 may continue to maintain the activated autonomous driving in step S19.

In addition, under the control of the processor 110, when it is determined that the autonomous vehicle 100 and the trailer 200 are not fastened or connected to each other as the result of analyzing the provided connection signal in step S20, the autonomous vehicle 100 may activate the SCC function based on this in step S21.

Subsequently, under the control of the processor 110, based on such a disconnected state of the trailer 200, the autonomous vehicle 100 may learn a speed-specific acceleration pattern of the autonomous vehicle 100 based on the activated SCC function in step S22.

Under the control of the processor 110, the autonomous vehicle 100 may acquire learning data to be used for the speed-specific acceleration pattern of the autonomous vehicle 100, and apply the acquired learning data to the deep learning model to train the deep learning model. The learning data described herein may be any data associated with the speed-specific acceleration pattern of the autonomous vehicle 100.

For example, as shown in (a) to (c) of FIG. 4, the autonomous vehicle 100 may learn a speed-specific acceleration pattern by acquiring learning data based on an SCC acceleration/deceleration pattern during driving and by performing learning based on the acquired learning data, under the control of the processor 110.

For example, as shown in (a) of FIG. 4, the autonomous vehicle 100 may accelerate the autonomous vehicle 100 from a reference speed to a first speed while the autonomous driving is in an activated state to learn an acceleration pattern of the first speed, under the control of the processor 110.

Alternatively, as shown in (b) of FIG. 4, the autonomous vehicle 100 may accelerate the autonomous vehicle 100 from the reference speed to a second speed, which is faster than the first speed, while the autonomous driving is in the activated state to learn an acceleration pattern of the second speed, under the control of the processor 110.

Alternatively, as shown in (c) of FIG. 4, the autonomous vehicle 100 may accelerate the autonomous vehicle 100 from the reference speed to a third speed, which is faster than the second speed, while the autonomous driving in the activated state to learn an acceleration pattern of the third speed, under the control of the processor 110.

Although FIG. 4 focuses on the acceleration pattern by speed, examples are not limited thereto. For example, instead of such a speed-specific acceleration pattern, the autonomous vehicle 100 may acquire learning data associated with a deceleration pattern while decelerating the autonomous vehicle 100 from the reference speed to a predetermined speed, and may learn a deceleration pattern by speed, or a speed-specific deceleration pattern, based on the acquired learning data.

Subsequently, under the control of the processor 110, the autonomous vehicle 100 may compare and analyze the learned acceleration pattern and the preset second normal pattern in step S23 to determine overloading in step S24.

Under the control of the processor 110, when overloading is determined as a result of comparison and analysis acquired by the comparing and analyzing step, the autonomous vehicle 100 may deactivate the autonomous driving and provide information about the deactivated autonomous driving through a USM and a cluster pop-up in step S25.

Alternatively, under the control of the processor 110, when overloading is not determined as the result of comparison and analysis, the autonomous vehicle 100 may continue to maintain the activated autonomous driving in step S26.

As described above, according to an embodiment of the present disclosure, under the control of the processor 110, the autonomous vehicle 100 may determine a loading level of the autonomous vehicle 100 and the trailer 200 based on a result of comparing and analyzing an acceleration or deceleration degree in a normal state and in a loaded state depending on a connection state of the trailer 200.

According to an embodiment of the present disclosure, under the control of the processor 110, the autonomous vehicle 100 may deactivate the autonomous driving when the determined loading level exceeds an allowable value, thereby avoiding or preventing erroneous control and enhancing the stability of using the autonomous driving.

Further, according to an embodiment of the present disclosure, under the control of the processor 110, when the autonomous driving is deactivated, the autonomous vehicle 100 may inform a driver of the deactivation of the autonomous driving by disabling a USM and providing a pop-up on a cluster, thereby preventing an unexpected accident that may occur when using the autonomous driving.

Further, according to an embodiment of the present disclosure, under the control of the processor 110, the autonomous vehicle 100 may control the autonomous driving to be activated or deactivated by determining a loading amount of the autonomous vehicle 100 or the trailer 200, rather than automatically turning off the autonomous driving when the trailer 200 is connected, thereby improving consumer satisfaction in terms of commercial value.

FIG. 5 is a diagram illustrating the activation of an autonomous driving based on an acceleration pattern, according to an embodiment of the present disclosure.

In a graph shown in FIG. 5, a horizontal direction represents time, a vertical direction represents speed, BS1 represents a normal state which indicates a preset normal pattern, BS2 represents a preset second normal pattern, and BS3 represents a preset first normal pattern. In addition, SP represents an overloading determination area.

For example, BS3 may be a baseline for determining whether to deactivate an autonomous driving based on a case where the autonomous vehicle 100 and the trailer 200 are connected (or fastened). In other words, BS3 may serve as a baseline for determining the deactivation of the autonomous driving function when the autonomous vehicle 100 is connected to the trailer 200.

Thus, under the control of the processor 110, the autonomous vehicle 100 may determine whether to activate the autonomous driving function by distinguishing or identifying a baseline based on whether the autonomous vehicle 100 and the trailer 200 are connected or disconnected.

For example, when an SCC acceleration pattern, learned in a state where the trailer 200 is connected or fastened, is below the BS3 baseline, the autonomous vehicle 100 may determine an excessive loading amount and deactivate the autonomous driving function, under the control of the processor 110. In other words, the autonomous vehicle 100 may apply a mounting criterion of the trailer 200 and determine an area in which the loading amount of the trailer 200 is excessive, and may then deactivate the autonomous driving function, under the control of the processor 110.

In contrast, BS2 may be a baseline for determining whether to deactivate the autonomous driving function based on a case where the autonomous vehicle 100 and the trailer 200 are not connected (or fastened).

For example, when an SCC acceleration pattern, learned in a state where the trailer 200 is not connected or fastened, is below the baseline of the BS2 baseline, the autonomous vehicle 100 may determine an excessive loading amount and deactivate the autonomous driving, under the control of the processor 110. In other words, the autonomous vehicle 100 may apply a non-mounting criterion of the trailer 200 and determine an area in which the loading amount of the autonomous vehicle 100 is excessive, and may then deactivate the autonomous driving, under the control of the processor 110.

The embodiments of the present disclosure described herein may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like.

Accordingly, the preceding detailed description should not be construed as restrictive but as illustrative in all respects. The scope of the embodiments of the present disclosure should be determined by reasonable interpretation of the appended claims, and all changes and modifications within the equivalent scope of the present disclosure are included in the scope of the present disclosure.

What is claimed is:

1. A method of controlling an autonomous vehicle, the method comprising:
acquiring, by a processor, a signal indicative of connection between the autonomous vehicle and a trailer;
activating, by the processor, an autonomous driving based on the acquired signal;
learning, by the processor, an acceleration pattern of the autonomous vehicle based on the activated autonomous driving;
determining, by the processor, overloading by comparing the learned acceleration pattern with a preset normal pattern; and
determining, by the processor, whether to maintain the activated autonomous driving based on a result of the determination on the overloading.

2. The method of claim 1, further comprising:
in response to determination of the overloading, deactivating, by the processor, the autonomous driving, and providing information related to the deactivated autonomous driving through a display.

3. The method of claim 2, further comprising:
in response to determination that there is no overloading, maintaining, by the processor, the activated autonomous driving.

4. The method of claim 1, wherein the preset normal pattern comprises a first normal pattern and a second normal pattern, and
wherein determining overloading comprises determining the overloading based on the first normal pattern when the autonomous vehicle and the trailer are determined as being connected based on the signal.

5. The method of claim 4, wherein determining overloading further comprises determining the overloading based on the second normal pattern when the autonomous vehicle and the trailer are determined as not being connected based on the signal.

6. The method of claim 1, wherein the autonomous driving comprises a smart cruise control (SCC).

7. A non-transitory computer-readable recording medium having a program recorded thereon, the program to direct a processor to perform acts of:
acquiring a signal indicative of connection between an autonomous vehicle and a trailer;
activating an autonomous driving based on the acquired signal;
learning an acceleration pattern of the autonomous vehicle based on the activated autonomous driving;
determining overloading by comparing the learned acceleration pattern with a preset normal pattern; and
determining whether to maintain the activated autonomous driving based on a result of the determination on the overloading.

8. An autonomous vehicle comprising a processor, wherein the processor is configured to:
acquire a signal indicative of connection between the autonomous vehicle and a trailer;
activate an autonomous driving based on the acquired signal;
learn a speed-specific acceleration pattern of the autonomous vehicle based on the activated autonomous driving;
determine overloading by comparing and analyzing the learned acceleration pattern and a preset normal pattern; and
determine whether to maintain the activated autonomous driving based on a result of the determination on the overloading.

9. The autonomous vehicle of claim 8, wherein the processor is further configured to:
when the overloading is determined, deactivate the autonomous driving, and provide information about the deactivated autonomous driving through a display.

10. The autonomous vehicle of claim 9, wherein the processor is configured to:
when no overloading is determined, maintain the activated autonomous driving.

11. The autonomous vehicle of claim 8, wherein the preset normal pattern comprises a first normal pattern and a second normal pattern, and
wherein the processor is configured to determine the overloading based on the first normal pattern when the autonomous vehicle and the trailer are connected based on the signal.

12. The autonomous vehicle of claim 11, wherein the processor is further configured to determine the overloading based on the second normal pattern when the autonomous vehicle and the trailer are not connected based on the signal.

13. The autonomous vehicle of claim 8, wherein the autonomous driving comprises a smart cruise control (SCC).
